(19) United States
(12) Patent Application Publication
(10) Pub. No.: US 2004/0107361 A1
(43) Pub. Date: Jun. 3, 2004

(54) System for high speed network intrusion detection

(76) Inventors: Michael C. Redan, Ottawa (CA); Matthew A. Thompson, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/305,950

(22) Filed: Nov. 29, 2002

(51) Int. Cl. G06F 11/30

(52) U.S. Cl. 713/201

(57) ABSTRACT

A network intrusion detection system for detection of an intrusion through the analysis of data units on a network connection is described herein. The network intrusion detection system provides enhanced memory performance through an interrupt handling routine that minimises calls to the operating system, and mitigates the performance overhead of copying data units from one memory location to another. Data units received from an external network are placed into a ring buffer for in place analysis to reduce data transfer overhead.

### FIELD OF THE INVENTION

The present invention relates generally to network intrusion detection systems. More particularly, the present invention relates to a method and system for detecting network intrusion over high bandwidth connections.

### BACKGROUND OF THE INVENTION

Intrusion detection is the process of monitoring a computer or a computer network for activity that threatens the security of the monitored resource. A network intrusion detection system (NIDS) examines data units, such as IP packets, traveling on the monitored network to detect possible attacks. This is usually accomplished by implementing the NIDS as a node on the network. Typically, the NIDS is an application running on a hardware platform that consists of standard, commercial components.

In operation, data units, such as Ethernet frames, arrive at the NIDS via the NIDS' network interface card (NIC). Normally, a NIC ignores all frames that are not addressed to it, but this is overcome by having the NIC run in promiscuous mode. In promiscuous mode, the NIC accepts all data units, regardless of intended destination.

The NIC generates an interrupt when a data unit is received. The generated interrupt is trapped by the operating system (OS) interrupt handling routines. Typically the NIC provides the OS with the memory location of the received data unit. Most modern NICs automatically put the frame data into a pre-defined area of OS memory using direct memory access (DMA). The NIDS receives the address of the received data unit from the OS and then using a packet filter, or other similar packet grabbing routines, copies the data unit to an area of memory reserved for the NIDS application. The NIDS then analyzes the packet for intrusion signatures. The main purpose of this preliminary processing is to identify packets that are definitely not malicious and to discard them from the NIDS data unit queue. This saves on later processing as data units that are clearly non-malicious are not analyzed.

Typically the OS uses a network protocol stack such as the TCP/IP stack to decode the data unit and pass the payload of the data unit to the NIDS application. This process involves copying the frame data from OS memory to application memory as the decoding progresses. Typically, a data unit is copied multiple times to different memory locations for processing by different parts of the protocol stack. The NIDS application then analyzes the data unit's payload and header for signatures that are associated with known attacks. Typically the signatures are stored as character strings in a database or table.

In networks with data traffic in excess of 10 Mbps, the repeated system calls to the OS for interrupt handling and repeated memory accesses become a bottleneck for NIDS applications. As data units begin to arrive faster than the NIDS and OS can handle and process, data units are dropped from the processing queue due to queue length restrictions. Though this can be mitigated through the use of a larger queue, the solution is at best a stop gap measure as the root of the problem is not the queue size and instead lies in the interrupt and memory handling delays. As the queue becomes fully populated, incoming data units are dropped from the queue, or are simply not added. As a result, only a fraction of incoming data units are inspected. This diminishes the utility of the NIDS.

This performance problem is not specific to intrusion detection. Other applications encounter the same performance bottleneck created by the OS, its protocol stack, and excessive memory access. Researchers have developed ways to bypass the operating system and its protocol stack. Two approaches in this field are Scheduled Transfer (ST) and Virtual Interface Architecture (VIA). Both these approaches require active communication with other hosts on the network. Active communication while possible for a NIDS, its primary role is to passively receive and analyse data units bound for other systems. Thus neither ST nor VIA are appropriate for implementation in NIDS.

One solution that is apparent at first glance is to simply increase the speed of the NIDS, either through upgrading the processor, or by connecting a pair of NIDS systems in parallel. The solution of simply increasing the processor speed does offer some advantages. An increased processor speed does allow the analysis of each packet to be performed in a shorter time increment, but the memory operations required to move the packet between the variety of memory locations impose a transfer limit that is not typically improved by a faster clock rate on the processor. Parallel NIDS are difficult to implement, as certain intrusion attacks, such as port scans, require that the NIDS know where all packets are destined and from where they were transmitted. A parallel NIDS would require that the two NIDS be able to share information about each data unit with each other. This would introduce problems with data transfer between the NIDS that is overly complex to solve.

It is, therefore, desirable to provide a NIDS that is capable of examining high data rate transfers on a network without dropping a substantial number of packets.

### SUMMARY OF THE INVENTION

It is an object of the present invention to obviate or mitigate at least one disadvantage of previous network intrusion detection systems. It is a further object of the present invention to provide a network intrusion detection system that detects data units on an external network connection that are indicative of a network intrusion.

In a first aspect of the present invention, there is provided a method of intrusion detection in a packet based network. The packet based network includes a network interface card for receiving data units, placing the received data units into predetermined memory locations, and generating interrupts when data units are received. The method of intrusion detection comprises the five following steps. The first step is to receive an interrupt from the network interface card. In response to receiving the interrupt, a data unit in a predetermined memory location is analyzed to determine if it is indicative of a network intrusion. When the analysis of the data unit is completed, a determination of whether or not a data unit is present in an adjacent predetermined memory location is made. If it is determined that there is a data unit present in an adjacent predetermined memory location, the subsequent data unit, is analysed to determine if it is indicative of a network intrusion. If the determination is made that there is no data unit present in the adjacent predetermined memory location the interrupt received from the network card is cleared.

In an embodiment of the first aspect of the present invention, prior to clearing the interrupt a wait state having a predetermined time interval is introduced. Following the wait state, the step of determining whether or not a data unit is present in an adjacent predetermined memory location is repeated. If it is determined again that no data unit is available, the interrupt is cleared, but if the data unit is available, it is analyzed to determine if it is indicative of a network intrusion. In an other embodiment of the first aspect of the present invention the step of generating an alert if a data unit is indicative of a network intrusion is added. In another embodiment of the present invention, the step of determining if a data unit is indicative of a network intrusion includes comparing the payload of the data unit to a plurality of known intrusion signatures to determine if a match is present, step of comparing the payload of the data unit may optionally includes performing a Boyer-Moore comparison of the data unit payload to the plurality of known intrusion signatures. In other embodiments of the first aspect of the present invention, the step of determining if a data unit is indicative of a network intrusion may include verifying the checksum of the data unit and optionally incrementing an illegal data unit counter when the checksum of a data unit is invalid, and inspecting the data unit to determine if the data unit is indicative of a port scan. Yet another embodiment of the present invention includes the step of a data unit from fragments prior to examining the reassembled data unit.

In a second aspect of the present invention there is provided a network intrusion detection system, for detecting network intrusions from an external network, having a database of signatures indicative of network intrusions, the network intrusion detection system. The network intrusion detection system includes a ring buffer, a network interface card and an analysis engine. The ring buffer is comprised of memory elements, and is for storing a plurality of data units. The network interface card, is operatively connected to both the external network for receiving data units, and the ring buffer for transferring the received data units into the memory elements of the ring buffer. The network interface card generates an interrupt when a data unit is transferred to an otherwise empty ring buffer. The analysis engine is operatively connected to the database for retrieving the signatures, the network interface card for receiving interrupts, and the ring buffer for retrieving data units from the memory elements. The analysis engine determines, upon receipt of an interrupt from the network interface card, if a retrieved data unit is indicative of a network intrusion using the database of signatures. It additionally analyses a subsequent data unit from the ring buffer, if one is available, upon completion of the prior determination, and determines if the subsequent retrieved data unit is indicative of a network intrusion using the database signatures If another data unit is unavailable from the ring buffer, the analysis engine clears the interrupt received from the network interface. In a presently preferred embodiment of the second aspect of the present invention, the analysis engine includes a delayed data unit retriever, a delayed intrusion detector and a delayed interrupt handler. The delayed data unit retriever is for retrieving a subsequent data unit from the ring buffer, if one is available, after waiting a fixed time interval. The delayed intrusion detector is for determining if the subsequent retrieved data unit is indicative of a network intrusion using the database signatures. The delayed interrupt handler is for clearing the interrupt received from the network interface card, after waiting the fixed time interval, if no subsequent data units are available from the ring buffer.

In an embodiment of the second aspect of the present invention, the analysis engine includes an alarm generator for generating an alarm when a retrieved data unit is indicative of a network intrusion. In other embodiments, the analysis engine includes a checksum validator for validating the checksum of a retrieved data unit and an illegal packet counter for tracking the number of retrieved data units with invalid checksums. In another embodiment, the database of signatures contains strings indicative of a network intrusion when present in the payload of a data unit and the analysis engine includes a comparator for comparing the database strings to the payload of retrieved data units. In embodiments of the present invention the comparator is a Boyer-Moore comparator, and may include means to compare the payload of retrieved data units to database strings using 64 bit registers and MMX instructions. In other embodiments of the present invention, the analysis engine includes a fragment detector for determining if the retrieved data unit is a data unit fragment and a fragment reassembler for reassembling a fragmented data unit. In other embodiments of the present invention there is provided a second network interface card, operatively connected to a second network for receiving data units, operatively connected to the ring buffer for transferring the received data units into the memory elements of the ring buffer, and operatively connected to the analysis engine for providing interrupts when a data unit is transferred to the ring buffer. In a presently preferred embodiment, there is provided a tap operatively connecting the first and second networks to the two network interface. In another embodiment, the first and second network interface cards operate in simplex mode, each card receiving data units from one of the internal network and the external network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a system of the present invention connected to an external network;

FIG. 2 is an illustration of a system of the present invention with a single network interface card connected to a ring buffer and an analysis engine;

FIG. 3 is a flowchart illustrating a method of the present invention;

FIG. 4 is a flowchart illustrating a method of reading packets from a network card according to an embodiment of the present invention; and

FIG. 5 is a flowchart illustrating a method of examining packets according to the present invention.

### DETAILED DESCRIPTION

Generally, the present invention provides a method and system for improving performance in a network intrusion detection system. The method bypasses the operating system memory handling routines, and does not require the NIDS to exchange information about memory locations with other hosts on the network.

To mitigate the memory handling delays of the prior art, the present invention reduces both the number of interrupts generated by its NIC and the number of times a data unit is copied to a different location in memory. In a typical data network, a single data unit is rarely transmitted in isolation, instead a data unit is typically part of a stream of data units. Thus when one data unit is received by a NIC, it is likely that there will be more data units arriving shortly. In the present invention, each received data unit is put into the next slot in a ring buffer, a memory construct that is described in more detail below. This allows the analysis engine to examine the data units in the ring, without requiring them to be copied to another location. To alert the analysis engine to the presence of a data unit in the ring buffer, the NIC generates an interrupt when the first data unit is placed in the ring. As more data units arrive, they are put into the ring buffer without generating an interrupt. The analysis engine examines the data unit after receiving the interrupt, and then checks the next slot in the ring buffer for the next data unit. This allows the analysis engine to receive many data units from only one interrupt. If the analysis engine determines that the next slot in the ring buffer is empty, it clears the interrupt. The NIC will generate an interrupt when a the next data unit is received. By not clearing the interrupt after a single data unit has been retrieved and analysed, the analysis engine allows a plurality of data units to be transferred to the ring buffer without the NIC generating extra interrupts. As a result, the NIC will only generate an interrupt when it is inserting a data unit into an otherwise empty ring. To further decrease the number of interrupts generated, it is possible to have the analysis engine pause for a fixed time interval prior to clearing the interrupt. After the pause, the next slot in the ring buffer can be examined to determine if it is still empty. If it is, the interrupt is cleared, but if a data unit is present, the analysis process continues. This greatly reduces the number of interrupts generated by the NIC, and causes an equivalent reduction in the use of the OS interrupt handling routines. In a presently preferred embodiment, the ring buffer is statically defined. It is a combination of the analysis engine and NIC using the same memory space, and the novel interrupt handling routine that provides additional performance to the present invention.

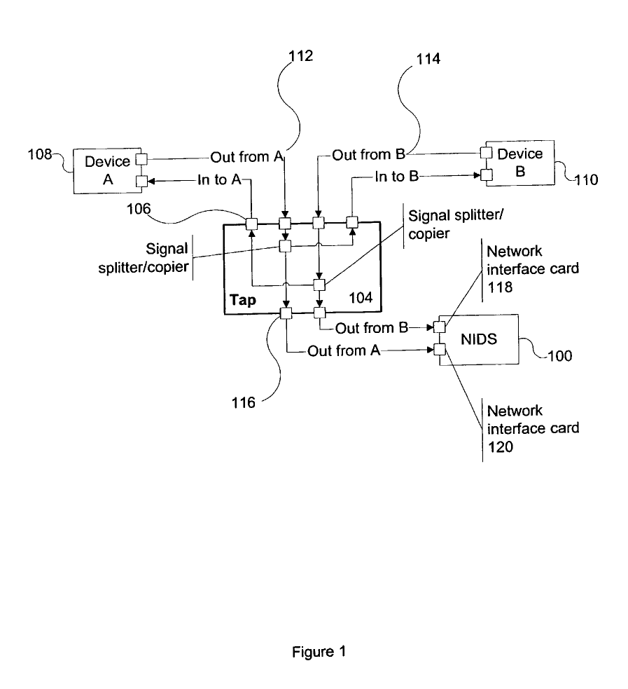

In a presently preferred embodiment, the NIDS of the present invention 100 listens to a single network segment/cable 112 using a tap 104 as illustrated in FIG. 1. The ports 106 are full duplex and receive the corresponding transmit and receive signals of the connected devices 108 and 110. The transmit signals 112 and 114 from each device are split, so that one copy of the signal is passed on to the other device, while the second copy goes to one of the two simplex ports 116 in the tap 104. These two simplex ports 116 lead to two separate network interface cards (NICs) 118 and 120 in the NIDS 100.Though each NIC typically can handle 100 Mbps, the network connection in FIG. 1 is capable of passing traffic at a rate of 100 Mbps in each direction, which necessitates dual cards. This configuration allows NIDS 100 to be a purely passive and transparent device on the network. By situating the tap 104 between a network switch and an external network connection, NIDS 100 can monitor all traffic in and out of the network to detect intrusions.

The two NICs 118 and 120 in NIDS 100 process their respective inputs in parallel, using duplicate but separate instances of the necessary data structures and programs. In the following discussion, we will refer to just one NIC until such time as the NIDS applications recombines the two traffic streams. The NIDS application is a standard executable application that can be executed on a variety of computer platforms.

This discussion assumes an initial state of there being no frames for the NIDS application to inspect. When a new frame arrives at the NIC 118 it generates an OS interrupt, as usual. In a presently preferred embodiment, the interrupt is trapped by the driver for NIC 118, which then generates no further interrupts until the interrupt is cleared by another process. The interrupt is cleared by an analysis engine, which will be discussed in detail below, when all the received data units have been processed.

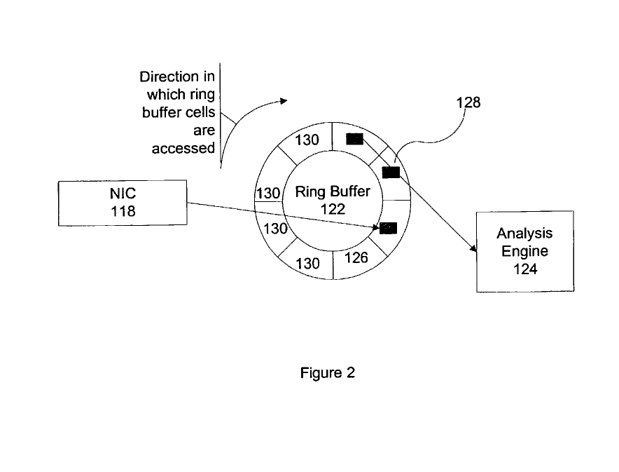

The NIC 118 immediately moves the received frame into the next available slot in a ring buffer 122 that is allocated in memory when the NIDS 100 is initialized. The ring buffer 122, as illustrated in FIG. 2, also referred to as a bounded queue, is a first in-first out (FIFO) queue with the property that when the last position in the queue has been written, the next slot to be filled will be the first position in the queue (potentially overwriting any data that was already there). In a presently preferred embodiment, NIC 118 uses DMA to move the received data unit into the ring buffer 122. The ring buffer can be structured as a static ring, a linked list, or a variety of other structures that will be known to and understood by one skilled in the art. In a presently preferred embodiment, a custom designed driver for NIC 118 is used to move the received data unit into the ring without requiring the generation of an interrupt.

The ring buffer 122 is in the memory of NIDS 100 and thus is also available to the analysis engine 124 of the NIDS application. The NIC 118 and the analysis engine 124 each maintain the address of the next slot in the ring to be written 126 or read 128, respectively. The analysis engine 124 receives the interrupt generated by NIC 118, and analyses the data unit in the next slot 128 in the ring buffer 122.

FIG. 2 illustrates a ring buffer 122, with empty cells 130. In this illustration empty cells 130 are filled in a clockwise direction. A few cells behind the one where a new packet is being written 126, the analysis engine 124 is reading a packet to begin processing it. The cells behind the cell being read are marked as empty. If the data unit in a cell or slot in the ring buffer is a fragmented data unit, the analysis engine will copy it to another location in memory until it has read all the fragments needed to reconstruct the data unit or until a timeout clock has expired. The slots in ring buffer 122 are not necessarily contiguous in memory, and reference to adjacent slots or cells should be understood to refer to slots or cells logically adjacent to each other.

As analysis engine 124 determines whether or not a data unit in a particular slot is part of an intrusion, NIC 118 continues to populate empty slots 130 with new data units. When analysis engine 124 finishes the analysis of a data unit, the slot that it occupies is marked as empty, and analysis engine 124 proceeds to the adjacent slot. If the adjacent slot in ring buffer 122 is empty analysis engine 124 has no further data units to analyse. Analysis engine 124 then clears the interrupt and goes into a wait state until NIC 118 generates another interrupt. In a presently preferred embodiment, when analysis engine 124 has no further data units to analyse it waits for a predetermined time interval, which can be either arbitrarily assigned or computed based on the speed of the network, and then checks ring buffer 122 to determine if there are any further data units to analyse. If there is a data unit in ring buffer 122, analysis engine 124 re-starts the analysis process. If not, analysis engine 124 tells the NIC 118 to re-enable interrupts, and then waits for an interrupt signalling a new data unit. This allows a greater number of data units to be analysed with a single interrupt. Because traffic on a data network is typically bursty in nature, NIC 118 often will receive data units faster than analysis engine 124 can process them. Ring buffer 122 can be sized to compensate for this, and allow data units to be buffered for analysis. Analysis engine 124 is able to analyse the buffered data units and clear the backlog when NIC 118 has completed receiving the burst of data units. By ensuring the ring buffer 122 is large enough (e.g. on the order of 30,000 maximum sized frames), it can be ensured that NIC 118 does not overrun analysis engine 124 and start overwriting data units that have not been inspected.

Through this entire data unit transfer process, no system calls to the operating system are required as only 1 interrupt is generated. There is also no use of OS memory management routines for copying data units between memory locations.

Once it begins to analyse a data unit, analysis engine 124 decodes the data unit to examine the payload. In a preferred embodiment, this is done using a custom stack to avoid either calling on the OS's implementation of the stack or having to copy the entire data unit to another location in memory. It is this aspect of the present invention that provides the memory performance necessary to keep up with the data units arriving from the network.

The analysis engine 124 verifies the data unit's checksum, reassembles fragmented data units, and decodes the transport layer protocol. It checks whether the data unit is part of a port scan (based on statistical information gathered from many data units over a pre-defined time period). If the data unit is part of a known attack, analysis engine 124 generates an alert and moves on to the next data unit. When the analysis engine finishes inspecting a data unit, it marks the appropriate location in the ring buffer as being available for new data.

During the analysis of a data unit, a presently preferred embodiment of analysis engine 124 determines the transport protocol in use (e.g. TCP, UDP, or ICMP), verifies the transport checksum (if applicable, as ICMP packets don't have checksums), and begins comparing the data unit's data payload against the appropriate detection rules for that type of data unit. If there's a match with a known attack, an alert is generated. The engine 124 then goes back to ring buffer 122 and examines the next data unit.

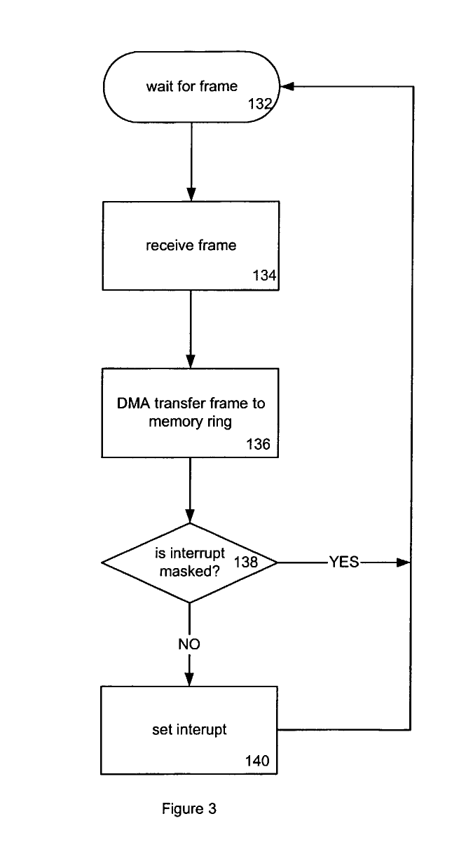

FIG. 3 illustrates a method of the present invention used by NIC 118 in the above process. NIC 118 waits for a data unit such as an Ethernet frame in 132. Upon receiving a frame in 134, NIC 118 transfers the received frame to the memory ring 122 using direct memory access in 136. The interrupt flag is examined in 138 to determine if the interrupt has already been masked. If the interrupt has not been masked, it is set in 140 and then the NIC waits for the next frame in 132. If the interrupt is masked, the analysis engine 124 is still analysing data units already in the ring, so there is no need for the interrupt to be triggered, thus the NIC returns to its waiting state 132. This method allows a plurality of data units to be received by the NIC and transferred into ring 122 with only one interrupt. The minimisation of interrupts assists in the minimisation of memory handling overhead. If the interrupt is not masked when a data unit such as a frame arrives, the analysis engine 124 will be idle as it will have finished processing the previously received data units. In this idle state, analysis engine 124 will not check ring 122. As a result, when a frame is received the state sof the interrupt in examined and the interrupt is masked if it previously was not.

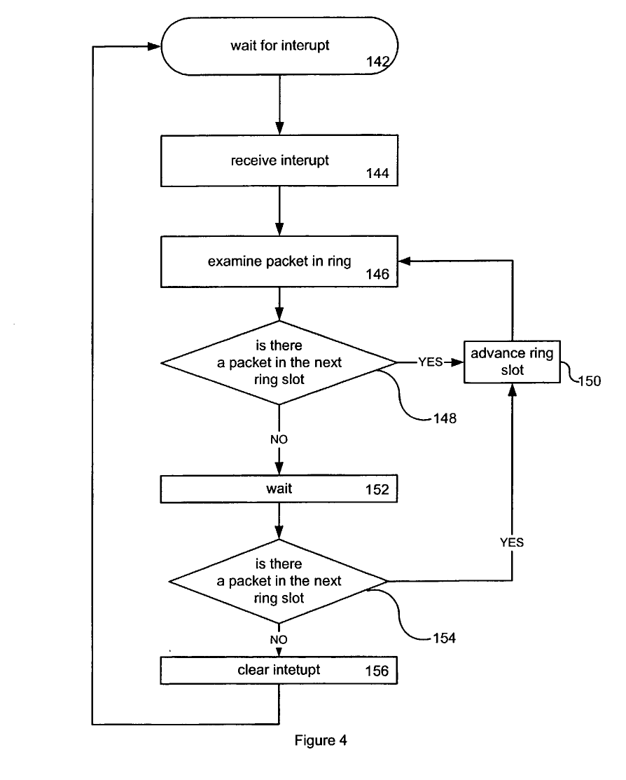

FIG. 4 illustrates a method of the present invention used by the analysis engine 124 in the above described process. In step 142, the analysis engine 124 is idle and waits for an interrupt from NIC 118. Upon receiving the interrupt in 144, the analysis engine 124 examines the packet in the ring 122, in step 146. Upon completing the analysis of the packet, the next slot in the ring is analysed to determine if it is in use in 148. If the slot holds a packet, the analysis engine advances to that slot in the ring buffer 122 in step 150 and returns to step 146 to analyse the packet. If the next slot in the ring is empty, analysis engine 122 enters a waiting state 152. The wait is designed to avoid an extra interrupt if packets arrive in a short amount of time. In a presently preferred embodiment, the wait is 2 milliseconds long. After the waiting period has expired, the next slot in the ring is analysed to determine if it is in use in 154. If the slot is occupied, the process moves to step 150, otherwise it is assumed that there is no new network traffic for analysis so the interrupt is cleared 156 and analysis engine 124 returns to 142 to wait for an interrupt.

One skilled in the art will appreciate that the wait in step 152 and the second inspection of the next slot in ring buffer 122 in step 154 are preferred, but optional. If both steps are omitted, the interrupt is cleared in step 156 immediately after no data unit is found in step 148. This allows for a stream of data units to be processed continuously, but will require an interrupt when the queue of data units is exhausted. The introduction of the wait provides the ability to further reduce the number of interrupts generated. The use of the wait is premised on the observation that network traffic tends to be bursty, and thus it is likely that a new data unit will arrive promptly after another has already been received. By introducing the wait, analysis engine 124 avoids clearing the interrupt too early which would result in more interrupts being generated. This avoids additional OS memory and interrupt handling, which has a severe performance penalty.

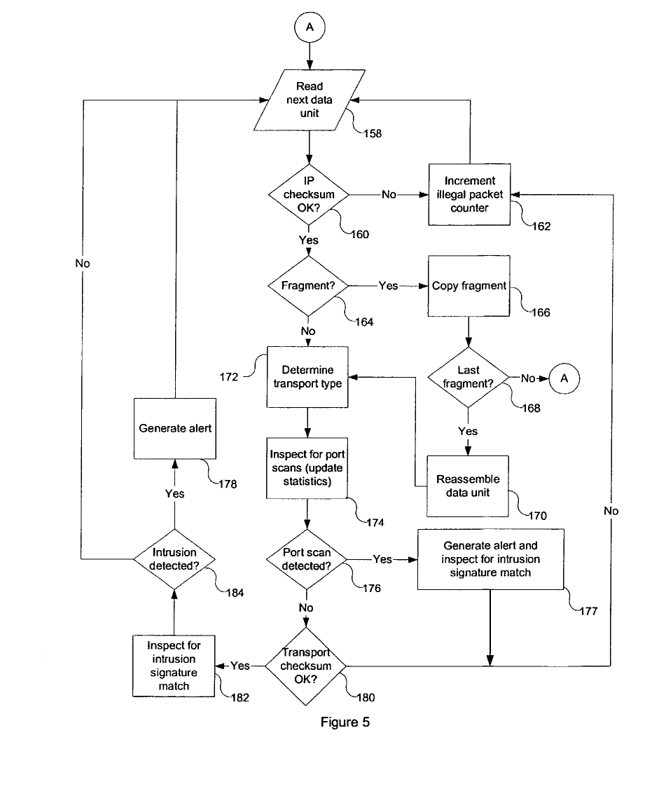

FIG. 5 illustrates the method of examining incoming data units according to a presently preferred embodiment of the invention. After reading a first data unit, NIDS 100 reads the next data unit in 158. The data unit is examined to determine if its checksum is valid in 160. If the checksum is invalid then an illegal packet counter is incremented in 162 and the next data unit is read. If the checksum is valid, the data unit is examined to determine if it is a fragment of a larger data unit in 164. If the received data unit is a fragment, it is copied to another area of memory in 166, and the fragment is examined to determine if it is the last fragment in the larger data unit in 168. If it is not the last fragment the next data unit is read, if it is the last fragment the data unit is reassembled in 170. After reassembling the data unit, the transport type of the entire data unit is determined in 172. If the data unit was not a fragment, the same transport determination for the received data unit is made at 172. After the transport type is determined the data unit is inspected to determine if it is part of a port scans in 174. If a port scan is detected at 176 an alert is generated in 177 and the payload of the data unit is inspected for a signature match, following which the illegal packet counter is incremented at 162. If no port scan is detected in 176, the transport checksum is examined to determine its validity in 180. If the transport checksum is invalid the illegal packet counter is incremented at 162, and a new data unit is read. If the transport checksum is valid in 180, the payload of the packet is inspected for a signature match in 182. The process of signature matching will be explained in greater detail below. If an intrusion signature is detected in 184 an alert is generated in 178 and a new data unit is read. If no intrusion signature is found in 184 then the next data unit is read in 158 to restart the process. Obviously, if no data unit is available to read in 158, NIDS 100 waits a fixed time interval, rechecks the ring buffer 122 and clears the interrupt if there are still no data units present for inspection.

In a presently preferred embodiment, a custom receive-only driver, with a pre-allocated large buffer (enough room for 16,000 data units), is used for capturing packets from the tap 104. Upon initialization, each NIC 118 is told the address of the first unit of the ring buffer 122. This address is often referred to as an Upload Packet Descriptor (UPD). As new packets come in, the NIC 118 will automatically upload the full packet into a UPD in main memory, and move to the next UPD to upload the next packet.

Under most circumstances, NIC 118 will do this without generating interrupts. This enables NIDS 100 to perform data unit matching without overhead from handling interrupts or moving data units to new memory locations. Interrupts are not generated as long as there are new data units for the analysis engine 124 to process, and are only generated when the analysis engine 124 has analysed all the data units in ring buffer 122 and has entered a wait state.

Using this technique over 120,000 data units can be processed with just one interrupt when the data unit per second rate is high (over 70,000 data units per second in one direction). As the data unit per second rate increases, the number of data units processed from one interrupt also increases. Even for low data unit per second rates (around 15,000 data units per second in one direction), roughly 1,000 data units can be processed with each interrupt, depending on the data unit size.

Along with transferring the data unit into the UPD, NIC 118 also provides some information about that data unit, such as checksums (IP, TCP, UDP as needed), total data unit length (including the Ethernet header), and any errors that happened during transmission.

This information can be used to validate that there are no illegal errors in the data unit that could cause problems during decoding. For instance, if the packet length reported in an IP header is larger than the actual packet length, it could cause the analysis engine 124 to attempt to decode data outside the buffer slot allocated for that packet, which may cause NIDS 100 to crash.

As described above, the UPDs forms a ring (last UPD has a link to the first one), so that the NIC will not run out of slots to upload data units to. When NIC 118 reaches “the end” of the list, it loops back to the “beginning” and starts reusing the UPDs that held data units that analysis engine 124 has already processed. This can be accomplished by creating a field in the UPD that indicates whether or not the packet has been processed yet.

Once a new data unit is copied into a UPD by the NIC 118, no further copies are made, unless it is a fragmented data unit. Analysis engine 124 works directly from ring buffer 122 to decode various networking protocol layers and check signatures. By reducing processor time spent on dynamic memory allocation and copying of the data unit between memory locations, overhead has been reduced.

In a preferred embodiment, analysis engine 124 uses a rule set of about 1,100 rules to determine the validity of a data unit. In a presently preferred embodiment, this set of rules is read in from a compressed file. As each rule is read in, it is sorted based on several different bits of information contained in the signature. The reading of the set of rules can also be performed at start-up of NIDS 100 to avoid the overhead of uncompressing the rules with the analysis of each data unit.

In the presently preferred embodiment there are three signature lists. Each list represents one of the three major protocols (TCP, UDP, and ICMP) under which the various rules are categorised. In the presently preferred embodiment, the TCP and UDP lists contain 65536 elements each (all of which are initialised to NULL). These element represent every possible destination port that a rule can have. Most of elements will remain NULL, as only a few dozen destination ports that are actually used in rules.

The rules have elements that are set to NULL, for two reasons. The first reason is that this allows new rules to be added at any time, without changing the structure of the rule list. The second reason is that by having a fixed number of elements, instead of storing just the elements needed, the lookup of rules can be performed in a shorter amount of time. Because the rules list is a fixed length, and contain pointers for every possible destination port, each incoming data unit can be easily inspected by determining the transport layer protocol, and then jumping to the section of the rules list associated with the destination port of the data unit. Because every NULL pointer requires 4 bytes of memory, there is a degree of memory inefficiency but this is offset by the fact that the analysis engine 124 does not have to descend trees, or perform calculations on every data unit before rule matching is even started.

There are some rules for TCP and UDP that are considered to be non-port specific. These rules are valid for either a range of ports (e.g., all ports less than 1024, or all ports between 5000 and 6000), or are valid for a small number of ports (such as the port pairing of 80 and 8080, or the trio of ports 53, 34, and 30000). There are also rules that are applicable to all ports. To handle these rules both TCP and UDP have an extra two lists each. The first extra list is for rules with a range of destination ports, and the second extra list is for rules with no specific destination port. These two lists are not sorted by their destination ports. When analysis engine 124 analyses a data unit, it examines the rules list to determine which rules apply to the data unit. The rules selected are used in selecting a sub-list that store the rule information. This sub-list is based on the destination address range that the rules are valid for. Generally there are between 5 and 10 different ranges contained in each rule set. Sorting based on the destination address range allows analysis engine 124 to skip entire sections of the rules list if an incoming packet is going to an address that is not valid for that section of the list.

Each rule in the rule list has a number of fields associated with it. In a presently preferred embodiment, the rules are ordered in the list by the number of fields that each rule has associated with it. Each field contains conditions that a data unit must satisfy in order for the rule to be relevant to the data unit. The conditions include: like TCP sequence numbers or ID numbers; predetermined strings in the payload; and specific TCP flags. Some fields associated with rules contain only information used to further refine or restrict the conditions of another field. Such fields typically specify information such as offset and depth of strings that are specified in other fields. Other signatures have multiple strings that must be matched to the payload of the data unit in order for the rule to be applicable, despite the fact that there are multiple strings, these conditions are considered to be a single field. One skilled in the art will readily appreciate that a number of different implementations, such as restricting each field to a single string, or requiring each field to specify its own depth and offset, can be implemented without departing from the scope of the invention.

The rules from a presently preferred embodiment that have been designed to examine hyper-text transfer protocol (http) based attacks are now described to illustrate the effectiveness of beside rules. There are roughly 450 rules with the destination port of 80. 400 of the 450 are so similar that after sorting they all lie together as beside rules. This means that during matching at least four checks per rule (source IP, source port, destination port, and flags) have been removed as once the four have been matched, the data unit is compared to the 400 beside rules, without rechecking the four initial conditions. Over the course of 400 rules the beside rules result in avoiding 1600 redundant comparison operations.

In order to reduce incorrect signature matching the rules are preferably sorted based on total signature length in descending order. This prevents the matching algorithm from reporting a match to the string “../” when it should report a match to the more specific string “../../../etc/passwd”.

This sorting allows further refinement to the searching process. The length of the payload of a data unit is known, and can be compared to the length of an intrusion signature. If the payload length is less than a signature's length then, none of the beside rules for that signature can be a match. Thus no comparison is required. Additionally, because signatures are sorted based on their lengths, it is possible to use the length of the data unit payload to dynamically shorten the rules list to allow analysis engine 124 to skip any comparisons in which the payload is shorter than a signature. In a presently preferred embodiment, a mid-pointer is implemented to point to the middle of the list. This allows the analysis engine 124 to avoid searching half the list if the payload lengths is shorter than the length of the signature corresponding to the mid-pointer. Because it is possible that a plurality of signatures have the same total length, the mid pointer typically points to either the first signature with the median length, or to a signature at either side of it. In an alternate embodiment, the rules list can be indexed by signature lengths, so that all signatures with the shorter lengths than a data units payload can be excluded from the comparisons.

ICMP rules are arranged differently than the TCP and UDP rules. This is a result of the fact that ICMP does not support destination ports. Instead, ICMP provides support for “itype”, a field inside the ICMP headers whose value ranges between 0 and 255. This results in an ICMP list that is shorter than the lists for either TCP or UDP. There are no itype ranges, each rule is applicable to either one specific value, or all itype values. This means that there are only two lists that cover all the ICMP rules, one that is statically 256 elements long, and one whose length depends on how many “itype=any” rules are provided. The balance of the sorting of the ICMP rules follows the same path as the rules for TCP and UDP.

The above organisation of rules for signature matching improves the performance of the analysis engine 124. In operation, the analysis engine 124 passes a data unit through filters for checksum error, fragmentation and port scans. After passing through the filters, the payload of the data unit is checked against the list of signature, which are organised as described above. The data unit's destination port is used to select from the list of signatures to create a set of rules to which the data unit payload is compared against. Each signature can have several fields that must be matched before analysis engine 124 can generate an alert. These fields can include source/destination IP address, TCP flags, sequence numbers, acknowledgement numbers, Time-To-Live (TTL) values, payload size, and payload content.

Many of the aforementioned fields can be checked by performing a simple numerical comparison between a value in the header and a value in the rule. Depending on where the number lies in the header it may be stored as either a little or a big endian value. The comparison between the values can be performed by switching the order of the numbers in the rules. This obviates, the requirement to swap byte order on the fly for incoming data units.

The most processor intensive step of data unit analysis is searching the payload of the data unit for signatures of known intrusions. To perform signature matching, analysis engine 124 must be able to identify a short character string in a potentially much larger data unit payload. The presently preferred embodiment employs a modified Boyer-Moore search as is illustrated below.

Each signature in a rule provides at least one string that must be matched in the payload of the data unit for an alert to be generated, this string is referred to as the search string. Each search string is represented as a table of 256 characters representing the ASCII table. Each entry in the table represents the distance from the end of the string of the corresponding ASCII character. If an element in the table is not in the search string it is assigned a value equivalent to the length of the search string.

In order to do Boyer-Moore string searching efficiently the sub-string to find, the length of that sub-string, the string that is being searched, the length of that string, and a table that describes how far each character is from the end of the sub-string must all be created, as will be known to one skilled in the art and as described above.

As an example, a data unit having the following 24 unit length payload

h h h r e b q q e y u y o o e t c / p a s s w d

is received. One of the signatures to be searched is the following signature of length 10, without either a specified offset or depth:

e t c / p a s s w d

The first step in the modified Boyer-Moore comparison is to determine if the search string length is longer than the payload length. Additionally, if an offset is specified for a signature, the length of the search string combined with the offset value must not exceed the length of the payload. If either the string length or the combination of string length and offset exceed the length of the payload a no-match is returned. In a presently preferred embodiment, these non-match results are minimised by the organisation of the rules.

If an offset is specified, and the payload is long enough, the first symbols in the payload are ignored to account for the offset. If no offset is specified, the comparison starts with the first symbol in the data unit. The length of the payload is adjusted by the depth value specified in the rule. If the signature is case sensitive, a case sensitive comparison is used, whereas an insensitive search is employed in the alternative. Case sensitive and insensitive searching and the related techniques are well known to those of skill in the art.

The signature is then lined up with the start of the payload, and the last symbol in signature is compared to the corresponding character in the payload. In the above example, “etc/passwd” is lined up with the start of the payload, and the last symbol in the signature, “d” is compared to the 10^{th} symbol in the payload, “y”.

| 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
|---|---|---|---|---|---|---|---|---|---|---|---|---|---|---|---|---|---|---|---|---|---|---|---|
| h | h | h | r | e | b | q | q | e | y | u | y | o | o | e | t | c | / | p | a | s | s | w | d |
| e | t | c | / | p | a | s | s | w | d | | | | | | | | | | | | | | |

Since they don't match, “y” is looked up in the signature's lookup table, to see how far it is from the end of the signature string. Because “y” does not appear in the signature, the value 10 is returned. The signature is then shifted 10 characters against the payload. This locates the “d” of the search string in the 20^{th} position. If there had been a “y” in the search string, the value returned by the search would have aligned the “y” in the search string with the “y” in the payload. The signature is then shifted by the resulting value of characters (10) against the payload. The “d” in the signature is now in position 20.

| 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
|---|---|---|---|---|---|---|---|---|---|---|---|---|---|---|---|---|---|---|---|---|---|---|---|
| h | h | h | r | e | b | q | q | e | y | u | y | o | o | e | t | c | / | p | a | s | s | w | d |
| | | | | | | | | | | e | t | c | / | p | a | s | s | w | d | | | | |

The comparison of “a” to “d” (in position 20) is performed. Once again, there is no match. The “a” in position 20 is used to find a new offset. There is an “a” four characters from the end of the signature string, so the lookup will return a value of 4. The search string is then shifted another 4 characters to align the a. If there had been more than one “a” in the search string, only the last instance would be recorded in the table, as an earlier value would result in an inaccurate search. The alignment of the characters now resembles:

| 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
|---|---|---|---|---|---|---|---|---|---|---|---|---|---|---|---|---|---|---|---|---|---|---|---|
| h | h | h | r | e | b | q | q | e | y | u | y | o | o | e | t | c | / | p | a | s | s | w | d |
| | | | | | | | | | | | | | | e | t | c | / | p | a | s | s | w | d |

A comparison of “d” to position 24 of the payload (another “d”) is performed. They match, so now a match on the rest of the string is attempted. In a conventional Boyer-Moore search, each character or the search string would be compared to the relevant payload character in sequence. If a character didn't match, the offsetting procedure would commence again, which in this case would have resulted in a no-match result. To provide a performance advantage, a presently preferred embodiment deviates from the standard Boyer-Moore search. In a presently preferred embodiment, NIDS 100 is based on an Intel® series processor, and has support for the MMX™ instruction set. At this point the standard algorithm states that a character for character comparison of the rest of the string should be performed, instead the present invention takes advantage of the MMX™ features of modem x86 computers, and compares 8 characters at a time using the 64-bit registers of the processor. The eight characters closest to the end of the string that have not been already compared are analysed in one operation. This allows analysis engine 124 to compare “tc/passw” from the payload to “tc/passw” in the signature to determine they match. Because the balance of the search string does not have 8 characters, analysis engine 124 performs a character by character comparison for the rest of the string. In this case analysis engine 124 compares “e” to “e” to determine that a match has occurred. The use of the MMX™ operation reduced the number of comparison operations required, and provides a substantial advantage during searching operations using considerably longer search strings.

One side effect of using MMX™ technology in the present embodiment is that programming of NIDS 100 is not portable to different processor architectures such as the PowerPC™ processors. In the presently preferred embodiment, the comparison routines are created in assembly language to ensure that the MMX™ operations are used instead of more generic, but portable, searching routines.

Other optimizations include. The above-described embodiments of the present invention are intended to be examples only. Alterations, modifications and variations, such as optimisations based on cache pre-fetching, which will fetch future data, such as signatures and data unit payloads, into the appropriate CPU cache levels, may be effected to the particular embodiments by those of skill in the art without departing from the scope of the invention, which is defined solely by the claims appended hereto.

What is claimed is:

1. A method of intrusion detection in a packet based network, the network including a network interface card for receiving data units, placing the received data units into predetermined memory locations, and for generating interrupts when data units are received, the method comprising:
receiving an interrupt from the network interface card;
determining if a data unit in a predetermined memory location is indicative of a network intrusion;
determining if a subsequent data unit is present in an adjacent predetermined memory location;
determining if the subsequent data unit, if present, is indicative of a network intrusion; and
clearing the interrupt if a subsequent data unit is not present.

2. The method of claim 1, further including, prior to clearing the interrupt, the steps of:
waiting a predetermined time interval;
determining if a subsequent data unit is present in the adjacent predetermined memory location; and
determining if the subsequent data unit, if present, is indicative of a network intrusion.

3. The method of claim 1, further including the step of generating an alert if it is determined that a data unit is indicative of a network intrusion.

4. The method of claim 1, wherein the step of determining if a data unit is indicative of a network intrusion includes comparing the payload of the data unit to a plurality of known intrusion signatures to determine if a match is present.

5. The method of claim 4, wherein the step of comparing the payload of the data unit includes performing a Boyer-Moore comparison of the data unit payload to the plurality of known intrusion signatures.

6. The method of claim 1, wherein the step of determining if a data unit is indicative of a network intrusion includes verifying the checksum of the data unit.

7. The method of claim 6, further including the step of incrementing an illegal data unit counter when the checksum of a data unit is invalid.

8. The method of claim 1, wherein the step of determining if a data unit is indicative of a network intrusion includes inspecting the data unit to determine if the data unit is indicative of a port scan.

9. The method of claim 1, further including the step of reassembling a data unit from fragments prior to examining the reassembled data unit.

10. A network intrusion detection system, for detecting network intrusions from an external network, having a database of signatures indicative of network intrusions, the network intrusion detection system comprising:
a ring buffer of memory elements, for storing a plurality of data units;
a network interface card, operatively connected to both the external network for receiving data units, and the ring buffer for transferring the received data units into the memory elements of the ring buffer, for generating an interrupt when a data unit is transferred to an otherwise empty ring buffer; and
an analysis engine, operatively connected to the database for retrieving the signatures, operatively connected to the network interface card for receiving interrupts, and operatively connected to the ring buffer for retrieving data units from the memory elements, for determining, upon receipt of an interrupt from the network interface card, if a retrieved data unit is indicative of a network intrusion using the database signatures, for retrieving a subsequent data unit from the ring buffer, if one is available, upon completion of the prior determination, for determining if the subsequent retrieved data unit is indicative of a network intrusion using the database signatures, and for clearing the interrupt received from the network interface card when no further subsequent data units are available from the ring buffer.

11. The network intrusion detection system of claim 10, wherein the analysis engine includes:
a delayed data unit retriever, for retrieving a subsequent data unit from the ring buffer, if one is available, after waiting a fixed time interval,
a delayed intrusion detector for determining if the subsequent retrieved data unit is indicative of a network intrusion using the database signatures, and
a delayed interrupt handler for clearing the interrupt received from the network interface card, after waiting the fixed time interval, if no subsequent data units are available from the ring buffer.

12. The network intrusion detection system of claim 10, wherein the analysis engine includes an alarm generator for generating an alarm when a retrieved data unit is indicative of a network intrusion.

13. The network intrusion detection system of claim 10, wherein the analysis engine includes a checksum validator for validating the checksum of a retrieved data unit.

14. The network intrusion detection system of claim 13, wherein the analysis engine further includes an illegal packet counter for tracking the number of retrieved data units with invalid checksums.

15. The network intrusion detection system of claim 10, wherein the database of signatures contains strings indicative of a network intrusion when present in the payload of a data unit.

16. The network intrusion detection system of claim 15, wherein the analysis engine includes a comparator for comparing the database strings to the payload of retrieved data units.

17. The network intrusion detection system of claim 16 wherein the comparator is a Boyer-Moore comparator.

18. The network intrusion detection system of claim 16, wherein the comparator include means to compare the payload of retrieved data units to database strings using 64 bit registers and MMX instructions.

19. The network intrusion detection system of claim 10, wherein the analysis engine includes a fragment detector for determining if the retrieved data unit is a data unit fragment.

20. The network intrusion detection system of claim 19, wherein the analysis engine includes a fragment reassembler for reassembling a fragmented data unit.

21. The network intrusion detection system of claim 10, further including a second network interface card, operatively connected to an internal network for receiving data units, operatively connected a second the ring buffer for transferring the received data units into the memory elements of the second ring buffer, and operatively connected to a second analysis engine for providing interrupts when a data unit is transferred to the second ring buffer.

22. The network intrusion detection system of claim 21, further including a tap operatively connecting the internal and external networks to the two network interface cards.

23. The network intrusion detection system of claim 22, wherein the first and second network interface cards operate in simplex mode, each card receiving data units from one of the internal network and the external network.
